(19) United States
(12) Patent Application Publication
(10) Pub. No.: US 2019/0286797 A1
(43) Pub. Date: Sep. 19, 2019

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Nobuhisa TAKAGI, Kanagawa (JP)

(73) Assignee: FUJI XEROX CO., LTD., Tokyo (JP)

(21) Appl. No.: 16/209,976

(22) Filed: Dec. 5, 2018

(30) Foreign Application Priority Data
Mar. 14, 2018 (JP) 2018-046958

(51) Int. Cl. G06F 21/32; G06F 21/44; G06K 9/00

(52) U.S. Cl. CPC G06F 21/32; G06K 9/00369; G06F 21/44

(57) ABSTRACT

An information processing apparatus includes a login information obtaining unit that obtains login information related to use authorization of an apparatus having a specific function; a detecting unit that detects a mobile terminal capable of transmitting information unaccompanied by use of the specific function while a user logs in the apparatus as the login information obtained by the login information obtaining unit is authenticated; and a registering unit that registers information for specifying the mobile terminal detected by the detecting unit and information for specifying the user indicated in the login information in association with each other.

### CROSS-REFERENCE TO RELATED APPLICATIONS

This application is based on and claims priority under 35 USC 119 from Japanese Patent Application No. 2018-046958 filed Mar. 14, 2018.

### BACKGROUND

### (i) Technical Field

The present invention relates to an information processing apparatus and a non-transitory computer readable medium storing an information processing program.

### (ii) Related Art

JP2017-175222A discloses an image processing apparatus which includes an obtaining section which obtains biometric information of a user who causes the image processing apparatus to execute a job, the biometric information being changed by reflecting a state of the user and a registration control section which controls an operation of registering information of the job and the biometric information of the user in association with each other.

JP2017-170647A discloses an image processing apparatus which includes a display section which displays an operation screen, an obtaining section which obtains biometric information of a user who uses the operation screen to perform an operation, the biometric information being changed by reflecting a state of the user, and a registration control section which controls an operation of registering information of the operation screen and the biometric information of the user in association with each other.

### SUMMARY

In an apparatus having a specific function, in a case where a user uses the specific function, in some cases, the apparatus requests the user to input login information on use authorization. The specific function is, for example, a printing function. In this case, the apparatus having the specific function is, for example, a printing press or a multifunction printer.

In this way, the apparatus having the specific function receives only information related to use of the specific function. However, in recent years, there are devices including various specific functions in an environment in which the user exists. Since the individual device receives only information related to the specific function, the information is distributed. In particular, since the apparatus shared by a plurality of users contacts with the plurality of users, aggregation of information is appropriate for the apparatus.

Aspects of non-limiting embodiments of the present disclosure relate to an information processing apparatus and a non-transitory computer readable medium storing an information processing program capable of integrating information as compared with a case where an apparatus having a specific function receives only information related to use of the specific function.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a login information obtaining unit that obtains login information related to use authorization of an apparatus having a specific function; a detecting unit that detects a mobile terminal capable of transmitting information unaccompanied by use of the specific function while a user logs in the apparatus as the login information obtained by the login information obtaining unit is authenticated; and a registering unit that registers information for specifying the mobile terminal detected by the detecting unit and information for specifying the user indicated in the login information in association with each other.

### BRIEF DESCRIPTION OF THE DRAWINGS

Exemplary embodiment(s) of the present invention will be described in detail based on the following figures, wherein:

FIG. 1 is a diagram illustrating an example of an outline configuration of an information processing system according to an exemplary embodiment of the invention;

FIG. 2 is a block diagram illustrating a hardware configuration of the information processing apparatus;

FIG. 3 is a block diagram illustrating an example of a functional configuration of the information processing apparatus;

FIG. 4 is a flowchart illustrating a flow of an association process among information processes performed by the information processing apparatus;

FIG. 5 is a diagram illustrating a list of information indicating detected mobile terminals;

FIG. 6 is a diagram illustrating management information in which information for specifying the mobile terminal is associated with information for specifying a user;

FIG. 7 is a flowchart illustrating a flow of an information receiving process among the information processes performed by the information processing apparatus;

FIG. 8 is a diagram illustrating an example in which the information processing apparatus 10 receives biometric information by relaying another device different from the mobile terminal; and

FIG. 9 is a flowchart illustrating a flow of an association process of the information processing apparatus 10 according to Modification 2.

### DETAILED DESCRIPTION

Hereinafter, examples of exemplary embodiments of the invention will be described with reference to drawings. In each of the drawings, the same or equivalent components and parts are given the same reference numerals. In addition, in some cases, a dimensional ratio of the drawing is exaggerated for convenience of description and is different from an actual ratio.

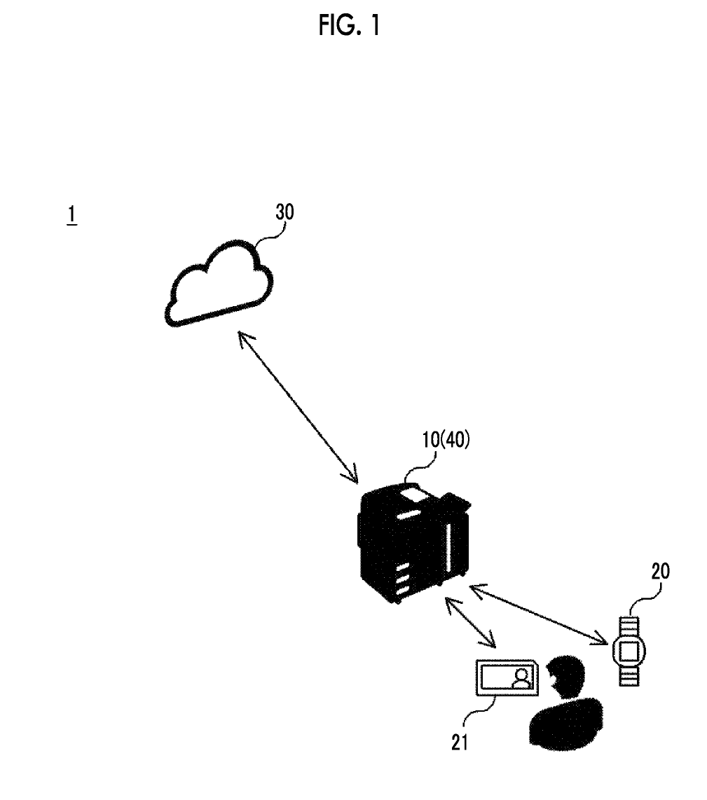

FIG. 1 is a diagram illustrating an example of an outline configuration of an information processing system according to the exemplary embodiment of the invention.

As illustrated in FIG. 1, an information processing system 1 includes an information processing apparatus 10, a mobile terminal 20, and a server 30.

The information processing apparatus 10 is embedded in an apparatus having a specific function. In the present exemplary embodiment, a case where the apparatus having the specific function is an image forming apparatus 40 having an image forming function will be described. The image forming apparatus 40 is an apparatus which executes functions related to image formation such as printing, copying, scanning, facsimile, and the like as specific functions according to an instruction of a user. In a case where the user uses the image forming function of the image forming apparatus 40, the information processing apparatus 10 verifies use authorization of the user based in login information related to the use authorization of the user. For example, in a case where an IC card reader included in the image forming apparatus 40 reads an IC card 21 on which an IC chip is embedded or in a case where the user inputs a user ID and a password to the image forming apparatus 40, the information processing apparatus 10 obtains the login information.

Further, the information processing apparatus 10 registers the mobile terminal 20 owned by the user in association with the user regardless of processes of the image forming apparatus 40. Details will be described below.

The mobile terminal 20 is a terminal carried by the user and is a terminal capable of transmitting information unaccompanied by the use of the image forming function of the image forming apparatus 40. The information unaccompanied by the use of the image forming function is personal information on the individual user and is, for example, biometric information on a living body of the user. The biometric information is, for example, information on heart rate, a pulse wave, a body temperature, quantity of motion, or the like of the user. The mobile terminal 20 obtains the biometric information from the user and transmits the obtained biometric information to the information processing apparatus 10. The biometric information transmitted from the mobile terminal 20 is received by the information processing apparatus 10 and is transmitted to the server 30 in association with the user (ID). The mobile terminal 20 is a wearable terminal which the user wears such as a clock or the like.

The server 30 is a local server or a cloud server, receives information related to image formation in the image forming apparatus 40 and the biometric information obtained by the mobile terminal 20 from the information processing apparatus 10, and stores the information and the biometric information.

Next, a hardware configuration of the information processing apparatus 10 will be described.

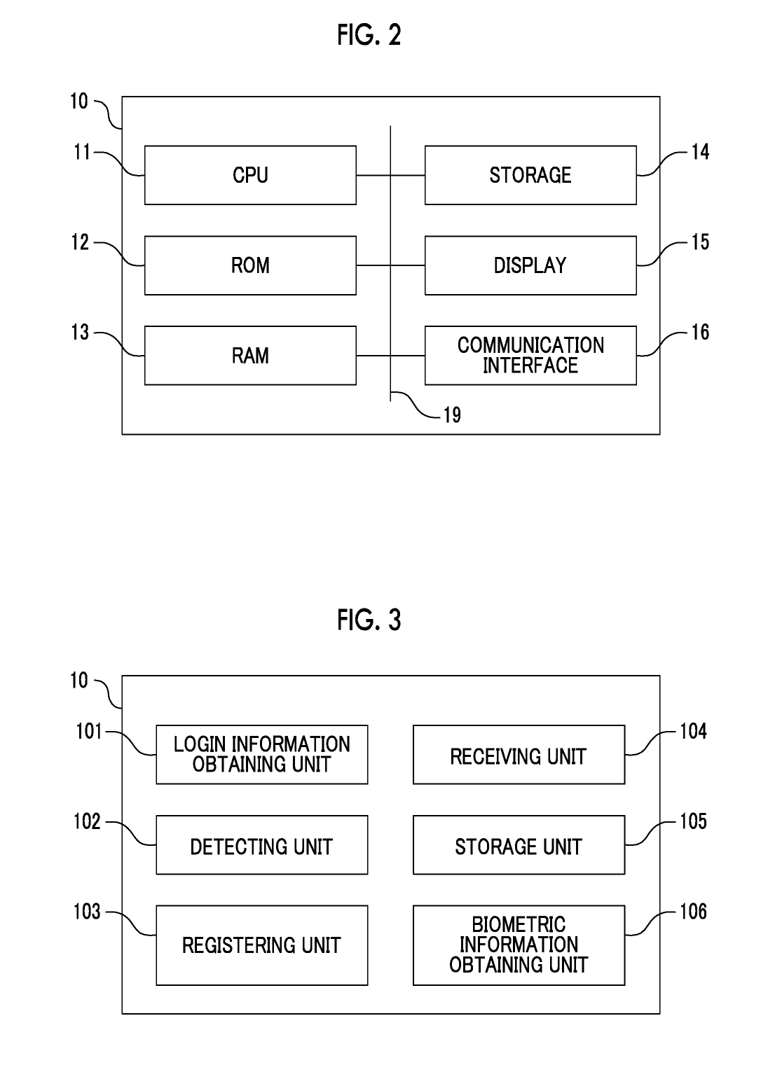

FIG. 2 is a block diagram illustrating the hardware configuration of the information processing apparatus.

As illustrated in FIG. 2, the information processing apparatus 10 is configured to include a central processing unit (CPU) 11, a read only memory (ROM) 12, a random access memory (RAM) 13, a storage 14, a display 15, and a communication interface 16. The respective components are communicably connected to one another via a bus 19. Each of the components may be shared with the image forming apparatus 40 as a hardware configuration of the image forming apparatus 40.

The CPU 11 is a central processing unit, and executes various programs and controls each of the units. That is, the CPU 11 reads a program from the ROM 12 or the storage 14 and executes the program with the RAM 13 as a work area. The CPU 11 controls each of the components described above and performs various types of arithmetic processes according to the program recorded in the ROM 12 or the storage 14. In the present exemplary embodiment, the ROM 12 or the storage 14 stores an information processing program.

The ROM 12 stores various types of programs and various data. The RAM 13 temporarily stores the program or the data as a work area. The storage 14 is configured with a hard disk drive (HDD) or a solid state drive (SSD), and stores various types of the programs and various data including an operating system.

The display 15 is, for example, a liquid crystal display and displays various types of information. The display 15 may employ a touch panel method and may function as an operation unit.

The communication interface 16 is an interface for communicating with other devices such as the mobile terminal 20 and the server 30, and uses standards such as Ethernet (registered trademark), FDDI, Wi-Fi (registered trademark), and the like.

Next, a functional configuration of the information processing apparatus 10 will be described.

FIG. 3 is a block diagram illustrating an example of the functional configuration of the information processing apparatus.

As illustrated in FIG. 3, the information processing apparatus 10 includes a login information obtaining unit 101, a detecting unit 102, a registering unit 103, a receiving unit 104, a storage unit 105, and a biometric information obtaining unit 106 as functional configurations. Each of the functional configurations is realized by the CPU 11 reading and executing the information processing program stored in the ROM 12 or the storage 14.

The login information obtaining unit 101 obtains login information related to the use authorization of the apparatus having the specific function. As described above, in the present exemplary embodiment, the apparatus having the specific function is the image forming apparatus 40 having the image forming function. In order to use the image forming apparatus 40, the login information obtaining unit 101 obtains the login information of the user from the IC card 21 which the user puts on the IC card reader of the image forming apparatus 40. The login information includes, for example, a user ID representing a user and a password associated with the user ID. The obtained login information is compared with management information stored in advance in the image forming apparatus 40 or the server 30, and it is determined whether or not the user has the use authorization by a comparison result. The management information is, for example, information in which the password and the use authorization are associated with the user ID (see FIG. 6). By inquiring the login information to the management information, it is determined whether or not a combination of the user ID and the password is correct. In a case where the combination is correct, the use authorization given to the user ID is further referred. In a case of the use within a range of the use authorization, the login information is authenticated.

The detecting unit 102 detects the mobile terminal 20 capable of transmitting the information unaccompanied by the use of the image forming function while the user logs in the image forming apparatus 40 as the login information obtained by the login information obtaining unit 101 is authenticated. As a specific example, it is assumed that the user approaches the image forming apparatus 40 while the user holds the mobile terminal 20 and the user logs in to use the image forming function of the image forming apparatus 40. At this time, the mobile terminal 20 is not particularly related to the use of the image forming function. However, the information processing apparatus 10 in the image forming apparatus 40 detects the mobile terminal 20. For example, the information processing apparatus 10 detects the mobile terminal 20 capable of communicating in the vicinity of the image forming apparatus 40 by short range wireless communication such as Bluetooth (registered trademark), Bluetooth (registered trademark) low energy (BLE), Wi-Fi (registered trademark), near field communication (NFC), and the like.

The registering unit 103 registers information for specifying the mobile terminal 20 detected by the detecting unit 102 and information for specifying the user indicated in the login information in association with each other. The information for specifying the mobile terminal 20 is a name, a text string or a number uniquely assigned to the mobile terminal 20 and is, for example, a MAC address of the mobile terminal 20. The information for specifying the user is the user ID included in the login information.

The receiving unit 104 receives the biometric information of the user from the mobile terminal 20 registered in association with the user by the registering unit 103.

After the registering unit 103 registers the information for specifying the mobile terminal 20 and the information for specifying the user in association with each other, the storage unit 105 stores the biometric information received from the mobile terminal 20 in association with the information for specifying the user. The biometric information stored in the storage unit 105 may be transmitted from the storage unit 105 to the server 30.

The biometric information obtaining unit 106 obtains the biometric information of the user from the user. That is, the biometric information obtaining unit 106 directly obtains the biometric information from the user without going through the mobile terminal 20. Accordingly, the information processing apparatus 10 has a sensor for obtaining the biometric information such as a pulse sensor or a heartbeat sensor (not illustrated) and the image forming apparatus 40 obtains the biometric information of the user in the image forming apparatus 40 as the biometric information obtaining unit 106.

Next, an operation of the information processing apparatus 10 will be described. First, an association process of associating the mobile terminal 20 which transmits the information unaccompanied by the use of the image forming function, with the login information of the user in the information processing apparatus 10 will be described. Next, an information receiving process of receiving the information unaccompanied by the use of the image forming function from the mobile terminal 20 in the information processing apparatus 10 after the association process will be described.

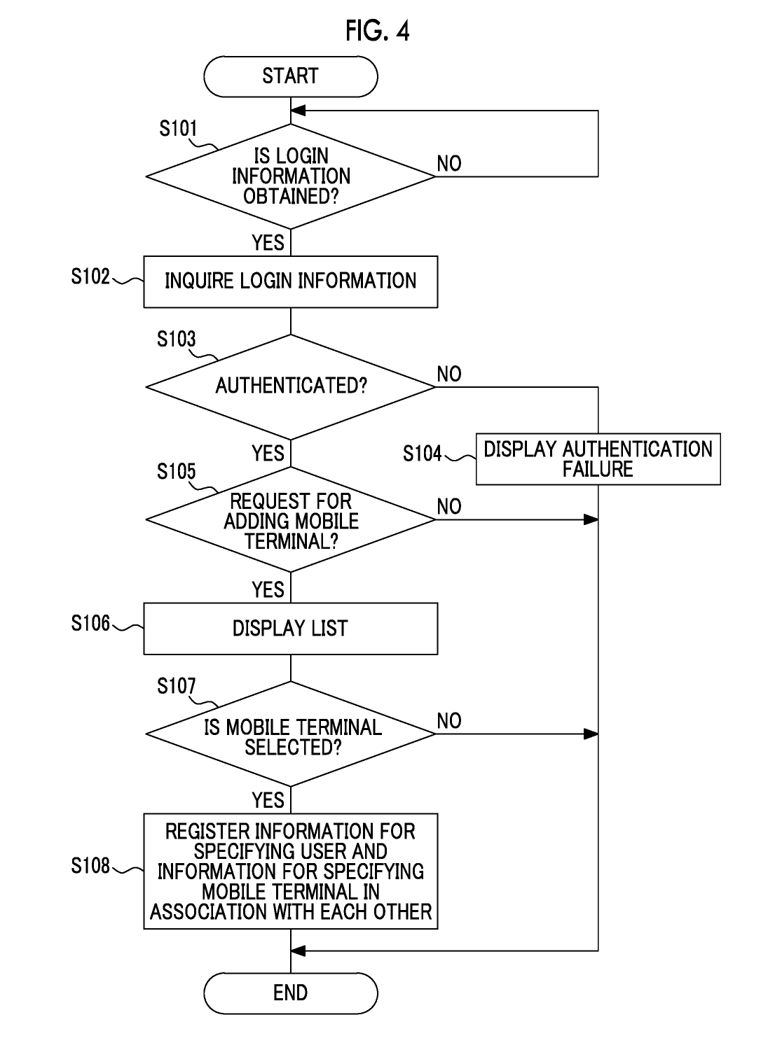

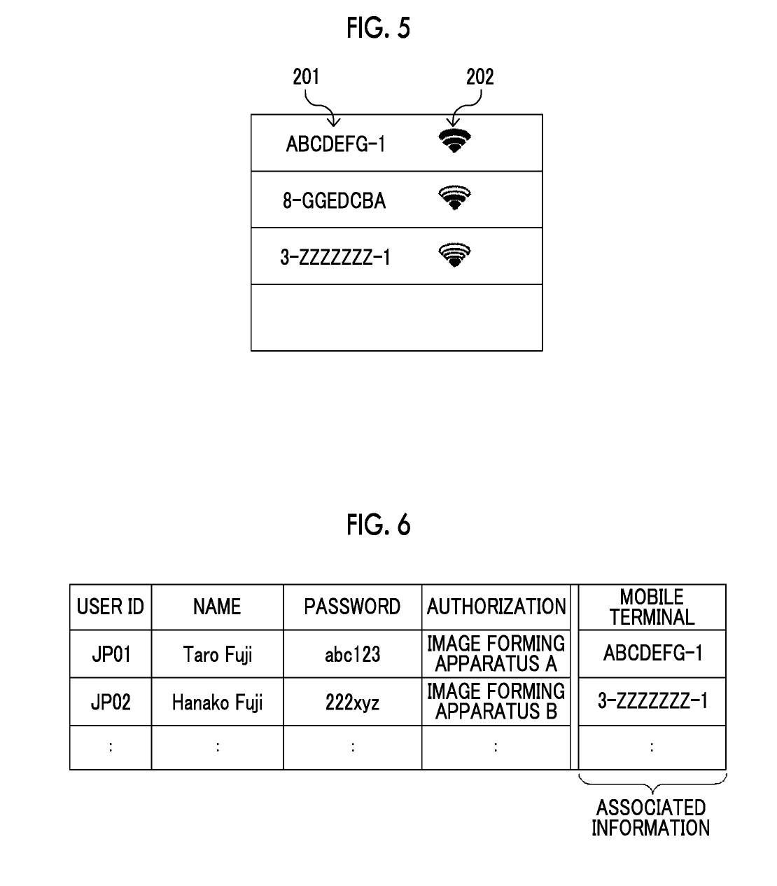

FIG. 4 is a flowchart illustrating a flow of the association process among information processes performed by the information processing apparatus. The CPU 11 reads the information processing program from the ROM 12 or the storage and executes the information processing program by developing the information processing program in the RAM 13 to perform the information process. FIG. 5 is a diagram illustrating a list of information indicating detected mobile terminals. FIG. 6 is a diagram illustrating the management information in which the information for specifying the mobile terminal is associated with the information for specifying the user.

The CPU 11 determines whether or not the login information obtaining unit 101 obtains the login information (step S101). As described above, the login information obtaining unit 101 obtains the login information by the user putting the IC card 21 on the IC card reader included in the image forming apparatus 40 or by the user inputting the user ID and the password via the display 15 or the mobile terminal 20.

In a case where the login information obtaining unit 101 does not obtain the login information (NO in step S101), the CPU 11 waits until the login information is obtained. In a case where the login information obtaining unit 101 obtains the login information (YES in step S101), the CPU 11 inquires the login information to the management information (step S102). The information processing apparatus 10 may store the management information or the server 30 may store the management information.

The CPU 11 determines whether or not the login information is authenticated according to a result of inquiring the login information to the management information (step S103). In a case where a combination of the user ID and the password included in the login information matches a combination of the user ID and the password stored in the management information, the login information is authenticated. In a case where the login information is not authenticated (NO in step S103), the CPU 11 displays a message that the authentication is failed on the display 15 and terminates the association process (step S104).

In a case where the login information is authenticated (YES in step S103), the CPU 11 determines whether or not there is a request for adding the mobile terminal 20 from the user (step S105). For example, along with a predetermined operation by the user, the information processing apparatus 10 displays an icon or a button for the request to add the mobile terminal 20 on the display 15 and the user selects the icon or the button by touching the icon or the button, so that the information processing apparatus 10 determines that there is the request for adding the mobile terminal 20. In a case where there is no request for adding the mobile terminal 20 (NO in step S105), the CPU 11 terminates the association process. Even in a case where the CPU 11 terminates the association process, as long as the user logs in, the user may use the image forming function in the image forming apparatus 40.

In a case where there is the request for adding the mobile terminal 20 (YES in step S105), the CPU 11 causes the detecting unit 102 to detect the mobile terminal 20 capable of short range wireless communication and displays information for specifying the detected mobile terminal 20 as a list (step S106). For example, FIG. 5 illustrates the list. In FIG. 5, a text string 201 is illustrated as the information for specifying the mobile terminal 20. Next to the text string 201, a radio field intensity 202 in a case where the detected mobile terminal 20 communicates with the information processing apparatus 10 is also illustrated. For example, as illustrated in FIG. 5, the radio field intensity 202 indicates that as the number of black figures representing radio waves increases, the intensity increases. In FIG. 5, the information for specifying the detected mobile terminal 20 is illustrated in order of strong radio field intensity.

The CPU 11 determines whether or not the specific text string 201 is selected from the list, that is, a predetermined mobile terminal 20 is selected from the list (step S107). In a case where the predetermined mobile terminal 20 is not selected (NO in step S107), the CPU 11 terminates the association process.

In a case where the predetermined mobile terminal 20 is selected (YES in step S107), the CPU 11 causes the registering unit 103 to register the text string 201 for specifying the selected mobile terminal 20 and the information for specifying the user indicated in the login information in association with each other (step S108). As illustrated in FIG. 6, the registering unit 103 adds associated information related to the mobile terminal 20 to the management information. Originally, the management information is information managed for using the specific functions of the image forming apparatus 40. However, the registering unit 103 associates the mobile terminal 20 not related to the use of the specific function of the image forming apparatus 40.

Next, the information receiving process of receiving the information unaccompanied by the use of the image forming function from the mobile terminal 20 in the information processing apparatus 10 after the association process described above will be described.

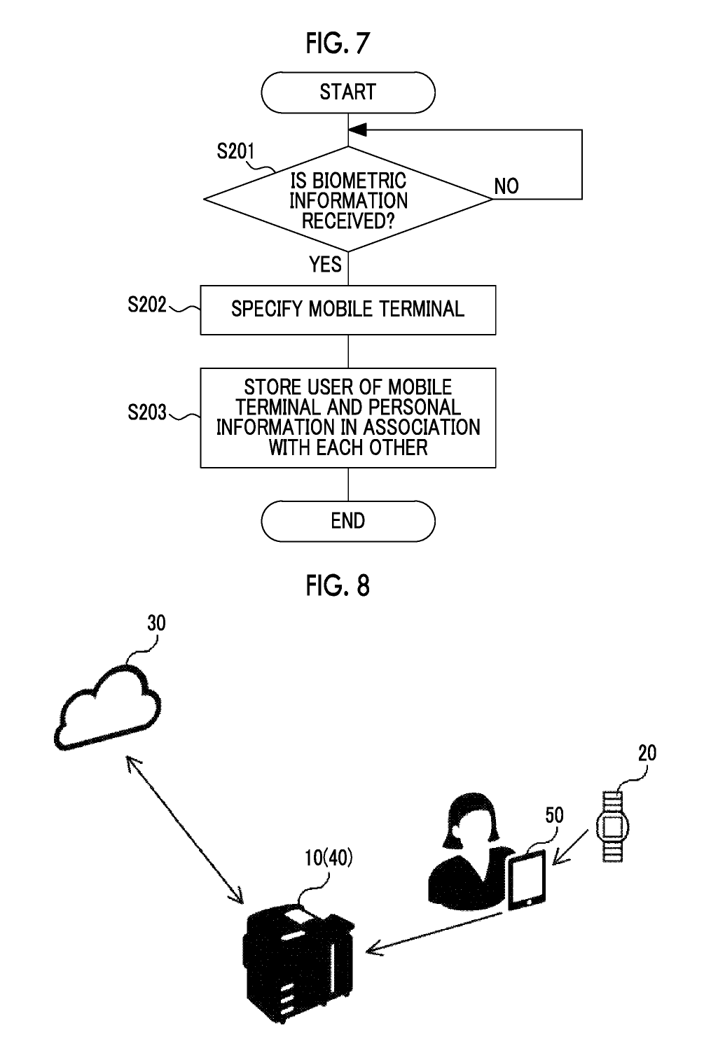

FIG. 7 is a flowchart illustrating a flow of the information receiving process among the information processes performed by the information processing apparatus. The CPU 11 reads the information processing program from the ROM 12 or the storage 14 and executes the information processing program by developing the information processing program in the RAM 13 to perform the information process.

The CPU 11 determines whether or not information unaccompanied by the use of the specific function of the image forming apparatus 40, that is, the biometric information which is personal information is received from the mobile terminal 20 (step S201).

In a case where the biometric information is not received (NO in step S201), the CPU 11 waits until the biometric information is received. In a case where the biometric information is received (YES in step S201), the CPU 11 specifies the mobile terminal 20 which transmits the biometric information (step S202). Here, the information for specifying the mobile terminal 20 as a transmission source is attached to the biometric information. Therefore, the CPU 11 refers to the information for specifying the attached mobile terminal 20 and specifies the mobile terminal 20 as the transmission source. The CPU 11 refers to the management information in FIG. 6 and determines the user in association with the specified mobile terminal 20 and the information (user ID) for specifying the user.

The CPU 11 causes the storage unit 105 to store the user ID associated with the mobile terminal 20 specified in step S202 and the received biometric information in association with each other in the storage 14 or the RAM 13 (step S203). The user ID and the biometric information may be transmitted to the server 30.

As described above, in a case where the mobile terminal 20 is once associated with the user by the association process illustrated in FIG. 4, the biometric information transmitted from the mobile terminal 20 is stored in association with the user by the information receiving process illustrated in FIG. 7. Therefore, in a case where the user approaches the image forming apparatus 40 so as to use the specific function of the image forming apparatus 40 or a case where the user passes by the image forming apparatus 40 by chance, the biometric information is collected by the information processing apparatus 10 without being conscious of the user. In this way, by the information processing apparatus 10, the image forming apparatus 40 functions as an information collecting apparatus which collects and stores the information not related to the specific function of the image forming apparatus 40, from the user. Specifically, in the exemplary embodiment described above, since the biometric information is collected as information unaccompanied by the use of the specific function of the image forming apparatus 40, it is conceivable to manage a health condition or the like of the user based on the collected biometric information.

Although the information process by the information processing apparatus 10 is described above, various improvements and modifications of the information processing apparatus 10 are possible within the scope of the technical idea of the invention.

In the exemplary embodiment described above, the example of the single image forming apparatus 40 is described. In addition, the present exemplary embodiment may also be applied to an environment in which a plurality of image forming apparatuses 40 exist. In a case where the plurality of image forming apparatuses 40 exist, the management information illustrated in FIG. 6 is stored in, for example, the server 30. Accordingly, the plurality of image forming apparatuses 40 use the common management information. In other words, as illustrated in FIG. 6, in the case where the information for specifying the mobile terminal 20 is associated with the user ID in one image forming apparatus 40, all of the image forming apparatuses 40 share the association.

In addition, in the exemplary embodiment described above, the image forming apparatus 40 is described as an example of the apparatus having the specific function, but the apparatus having the specific function is not limited to the image forming apparatus 40. The invention may also be applied to another device installed in an office or a public facility and used by a plurality of people. For example, the invention may be applied to the IC card reader or the like managing an entrance and an exit of the office or the like. In a case where the user enters or exits the office, the IC card reader communicates with the IC card put by the user to obtain the information such as a user ID and a password. Here, as described above, the mobile terminal which transmits personal information not related to a function of the entrance and the exit may be associated with the management information for authenticating the entrance and the exit by the IC card reader. Hereinafter, the modifications will be further described.

Modification 1

In the exemplary embodiment described above, the biometric information is received from the mobile terminal 20 in association with the user ID of the management information. Further, in a case where the biometric information to which the information for specifying the mobile terminal 20 is attached is transmitted after the mobile terminal 20 is associated with the management information, the information processing apparatus 10 may receive the biometric information by relaying another device different from the mobile terminal 20.

FIG. 8 is a diagram illustrating an example in which the information processing apparatus 10 receives the biometric information by relaying another device different from the mobile terminal.

In the example illustrated in FIG. 8, the user has the wearable mobile terminal 20 which obtains the biometric information from the user and further, as another device, carries a mobile terminal 50 such as a tablet or a smartphone. The mobile terminal 50 is connected to the mobile terminal 20 by short range wireless communication and the biometric information obtained by the mobile terminal 20 is sequentially transmitted to the mobile terminal 50 together with the information for specifying the mobile terminal 20. In addition, as illustrated in FIG. 6, it is assumed that the mobile terminal 20 and the mobile terminal 50 are already registered as mobile terminals related to the user ID in the management information.

Here, in a case where the mobile terminal 50 receives and accumulates the biometric information from the mobile terminal 20 and the user approaches the image forming apparatus 40, the mobile terminal 50 collectively transmits the biometric information to the information processing apparatus 10. In this case, the information processing apparatus 10 specifies the related user ID from the information for specifying the mobile terminal 20 attached to the biometric information and stores the biometric information in association with the user ID. That is, in the information processing apparatus 10, it is not a problem that the mobile terminal 50 which communicates in a case of receiving the biometric information is a device different from the mobile terminal 20. The information processing apparatus 10 refers to only the received biometric information and the information for specifying the mobile terminal 20 attached to the biometric information and stores the user ID and the biometric information in association with each other.

Modification 2

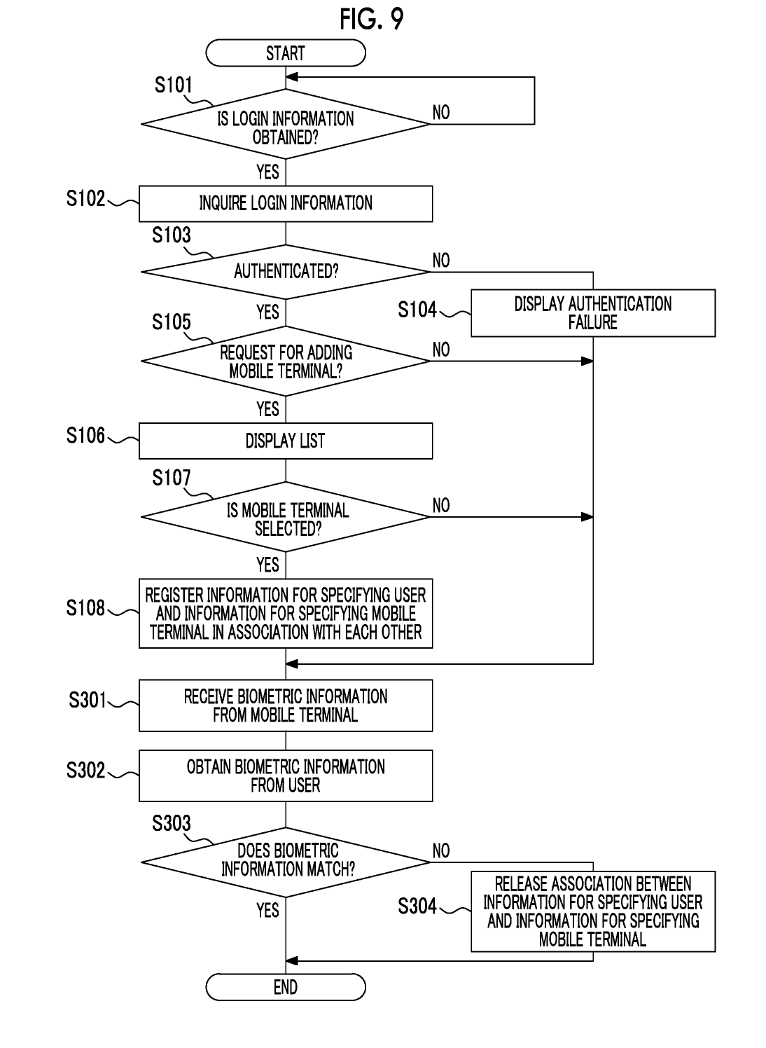

FIG. 9 is a flowchart illustrating a flow of the association process of the information processing apparatus 10 according to Modification 2. As a premise of the association process illustrated in FIG. 9, the information processing apparatus 10 includes the biometric information obtaining unit 106 which obtains the biometric information of the user.

In addition, in the association process illustrated in FIG. 9, the same reference numerals are attached to steps having the same contents as the association process illustrated in FIG. 4. That is, steps S101 to S108 are the same as the steps of the association process illustrated in FIG. 4. Therefore, the description up to step S108 will be omitted and step S301 and following steps will be described.

The CPU 11 receives the biometric information from the mobile terminal 20 (step S301). Here, the biometric information may be directly received from the mobile terminal 20 or may be received via another mobile terminal 50 as described in Modification 1. Next, the CPU 11 causes the biometric information obtaining unit 106 to directly obtain the biometric information from the user (step S302).

The CPU 11 determines whether or not the biometric information received in step S301 matches the biometric information obtained in step S302 (step S303). For example, in a case of obtaining information of pulse waves as biometric information in step S301 and step S302, the CPU 11 determines whether or not the pulse waves match. In the case of determining whether or not pieces of the biometric information match and even in a case where numerical values do not strictly match, a predetermined error may be permitted and it may be determined that the numerical values match.

In a case where the pieces of the biometric information match (YES in step S303), the CPU 11 terminates the association process.

In a case where the biometric information does not match (NO in step S303), the CPU 11 releases association between the information for specifying the user and the information for specifying the mobile terminal 20 associated in step S108 (step S304). In a case where the biometric information does not match, there is a possibility that the user tries to associate the incorrect mobile terminal 20 with the user ID in step S107. Then, the CPU 11 terminates the association process. Alternately, after step S304, the CPU 11 returns to the process in step S106 and causes the user to select the mobile terminal 20 again.

In this way, in Modification 2, whether or not the user selects the correct mobile terminal 20 in step S107 is verified.

Modification 3

In the exemplary embodiment described above, as illustrated in FIG. 5, in the case where the information processing apparatus 10 detects a plurality of mobile terminals 20 by short range wireless communication, all of the mobile terminals 20 are displayed on the list. However, in Modification 3, the mobile terminals 20 to be displayed on the list are limited. A procedure for limiting the mobile terminals 20 to be displayed on the list will be described below.

First, the information processing apparatus 10 detects all of the mobile terminals 20 capable of communicating by short range wireless communication. Here, the information processing apparatus 10 obtains the information for specifying all of the mobile terminals 20 capable of communicating by short range wireless communication. The information processing apparatus 10 inquires all of the detected mobile terminals 20 with the mobile terminals already associated with the user ID in the management information illustrated in FIG. 6 and determines whether or not the detected mobile terminal 20 and the mobile terminal already associated with the user ID match. In a case where the detected mobile terminal is the mobile terminal already associated with the specific user ID, the mobile terminal is removed from the list illustrated in FIG. 5.

As a result, only the mobile terminal 20 not registered in the management information remains on the list. In a case where only one mobile terminal 20 remains on the list, the information processing apparatus 10 may automatically register the mobile terminal 20 remaining on the list in association with the user ID in the management information without waiting for the selection of the user in step S107 in FIG. 4.

The process described above may also be realized by a dedicated hardware circuit. In this case, the process may be executed by one hardware or may be executed by a plurality of pieces of hardware.

In addition, the program for operating the information processing apparatus 10 may be provided by a computer readable recording medium such as a universal serial bus (USB) memory, a flexible disk, a compact disc read only memory (CD-ROM) and may be provided by online via a network such as an internet. In this case, the program recorded on the computer readable recording medium is usually transmitted to a memory, a storage, or the like and is stored in the memory, the storage, or the like. Further, the program may be provided as a single application software or may be incorporated into a software of each of the devices as a function of the information processing apparatus 10 or the image forming apparatus 40.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a login information obtaining unit that obtains login information related to use authorization of an apparatus having a specific function;
a detecting unit that detects a mobile terminal capable of transmitting information unaccompanied by use of the specific function while a user logs in the apparatus as the login information obtained by the login information obtaining unit is authenticated; and
a registering unit that registers information for specifying the mobile terminal detected by the detecting unit and information for specifying the user indicated in the login information in association with each other.

2. The information processing apparatus according to claim 1, further comprising:
a receiving unit that receives the information unaccompanied by the use of the specific function from the mobile terminal; and
a storage unit that, after the information for specifying the mobile terminal and the information for specifying the user are registered in association with each other, stores the information unaccompanied by the use of the specific function received from the mobile terminal in association with the information for specifying the user.

3. The information processing apparatus according to claim 2,
wherein the receiving unit receives the information unaccompanied by the use of the specific function and the information for specifying the mobile terminal by relaying another device different from the mobile terminal, from the mobile terminal.

4. The information processing apparatus according to claim 1,
wherein the information unaccompanied by the use of the specific function is personal information on the user.

5. The information processing apparatus according to claim 2,
wherein the information unaccompanied by the use of the specific function is personal information on the user.

6. The information processing apparatus according to claim 3,
wherein the information unaccompanied by the use of the specific function is personal information on the user.

7. The information processing apparatus according to claim 4,
wherein the personal information is biometric information on a body of the user.

8. The information processing apparatus according to claim 5,
wherein the personal information is biometric information on a body of the user.

9. The information processing apparatus according to claim 6,
wherein the personal information is biometric information on a body of the user.

10. The information processing apparatus according to claim 7, further comprising:
a biometric information obtaining unit that obtains the biometric information of the user from the user,
wherein after the information for specifying the mobile terminal and the information for specifying the user are associated with each other, the registering unit compares the biometric information of the user obtained by the biometric information obtaining unit with the biometric information detected by the mobile terminal as the information unaccompanied by the use of the specific function and in a case where the biometric information of the user obtained by the biometric information obtaining unit and the biometric information detected by the mobile terminal do not match, releases association between the information for specifying the user and the information for specifying the mobile terminal associated with each other.

11. The information processing apparatus according to claim 8, further comprising:
a biometric information obtaining unit that obtains the biometric information of the user from the user,
wherein after the information for specifying the mobile terminal and the information for specifying the user are associated with each other, the registering unit compares the biometric information of the user obtained by the biometric information obtaining unit with the biometric information detected by the mobile terminal as the information unaccompanied by the use of the specific function and in a case where the biometric information of the user obtained by the biometric information obtaining unit and the biometric information detected by the mobile terminal do not match, releases association between the information for specifying the user and the information for specifying the mobile terminal associated with each other.

12. The information processing apparatus according to claim 9, further comprising:
a biometric information obtaining unit that obtains the biometric information of the user from the user,
wherein after the information for specifying the mobile terminal and the information for specifying the user are associated with each other, the registering unit compares the biometric information of the user obtained by the biometric information obtaining unit with the biometric information detected by the mobile terminal as the information unaccompanied by the use of the specific function and in a case where the biometric information of the user obtained by the biometric information obtaining unit and the biometric information detected by the mobile terminal do not match, releases association between the information for specifying the user and the information for specifying the mobile terminal associated with each other.

13. The information processing apparatus according to claim 1,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

14. The information processing apparatus according to claim 2,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

15. The information processing apparatus according to claim 3,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

16. The information processing apparatus according to claim 4,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

17. The information processing apparatus according to claim 5,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

18. The information processing apparatus according to claim 6,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

19. The information processing apparatus according to claim 7,
wherein in a case where the detecting unit detects a plurality of mobile terminals, the registering unit removes the mobile terminal specified by the information for specifying the mobile terminal already registered by the registering unit and associates information for specifying the remaining unregistered mobile terminals with the information for specifying the user who logs in.

20. A non-transitory computer readable medium storing an information processing program causing a computer to execute a function, the function comprising:
obtaining login information related to use authorization of an apparatus having a specific function;
detecting a mobile terminal capable of transmitting information unaccompanied by use of the specific function while a user logs in the apparatus as the login information obtained in the obtaining is authenticated; and
registering information for specifying the mobile terminal detected in the detecting and information for specifying the user indicated in the login information in association with each other.
